(19) United States
(12) Patent Application Publication
(10) Pub. No.: US 2014/0064978 A1
(43) Pub. Date: Mar. 6, 2014

(54) Multi-Axis Balancing Propellers and Methods for Balancing Same

(71) Applicant: HORIZON HOBBY, INC., Champaign, IL (US)

(72) Inventor: Mario Enrique Somenzini, Champaign, IL (US)

(73) Assignee: Horizon Hobby, Inc., Champaign, IL (US)

(21) Appl. No.: 13/644,759

(22) Filed: Oct. 4, 2012

Related U.S. Application Data
(60) Provisional application No. 61/695,609, filed on Aug. 31, 2012.

(51) Int. Cl. B64C 11/16; B23P 6/00

(52) U.S. Cl. 416/223 R; 29/889.1

(57) ABSTRACT

Multi-axis balancing propellers and methods of balancing multi-axis balancing propellers along multiple axes are disclosed herein. In some embodiments, a propeller comprises a first blade extending from a hub in a first direction along a first axis, a second blade extending from the hub in a second direction along the first axis, a first balancing ear extending from the hub in a third direction along a second axis, and a second balancing ear extending from the hub in a fourth direction along the second axis.

### FIELD

This invention relates generally to aircraft propellers, and more specifically to an improved propeller, apparatus, and method for propeller balancing, particularly for model aircraft propellers.

### BACKGROUND

One important aspect of a flying model airplane is the model airplane's propeller, and one important aspect of the model airplane's propeller is the balance of the propeller. In general, an airplane (a model aircraft or full-size aircraft) will perform better with a properly-balanced propeller than with an unbalanced propeller.

As with most aircraft propeller systems, flying model aircrafts' propeller systems typically include a high speed rotating shaft or other elongated member that suspends and rotates the propeller. These propeller systems normally experience a certain amount of vibration caused by an imbalance in the propeller. Such vibrations, if not corrected, can cause the aircraft to run in an inefficient manner, and sometimes even fail.

Equal weight distribution, or balance, of the propeller reduces such undesired vibrations, and less propeller vibration increases the useful life of the model aircraft powertrain. In general, the principle of balancing a propeller is to equally distribute weight around the central portion, or hub, of the propeller in attempt to move the propeller's center of gravity to align with the propeller's center mounting hole. A balanced propeller will remain stationary when stopped along any axis.

The conventional method of balancing a propeller (for both model aircrafts and full-size aircrafts) is to alter the propeller itself by adding or removing weight. Generally mass (weight) is added to the light blade(s), and/or mass (weight) is removed from the heavy blade(s) of the propeller. For example, when balancing a two-bladed, wooden propeller, weight can be removed from a heavy side of the propeller by sanding the heavy side to remove a portion of the wood and its accompanying weight.

### SUMMARY

One or more of the disclosed embodiments relate to a multi-axis balanced propeller and a method for balancing the same. In a first embodiment, a propeller is disclosed. The propeller comprises a first blade extending from a hub in a first direction along a first axis. The propeller comprises a second blade extending from the hub in a second direction along the first axis. The propeller also comprises a first balancing ear extending from the hub in a third direction along a second axis. The propeller additionally includes a second balancing ear extending from the hub in a fourth direction along the second axis.

In a second embodiment, an apparatus comprising a propeller is disclosed. The propeller comprises a blade assembly comprising a first blade, a second blade, and a hub. The hub has a center mounting hole, and the first blade and the second blade are disposed around the center mounting hole and extending from the hub. The blade assembly is configurable to balance the propeller along a first axis. The propeller also comprises a balancing assembly comprising a first balancing extension, a second balancing extension, and a second hub. The second hub has a second center mounting hole, and the first balancing extension and the second balancing extension are disposed around the second center mounting hole and extending from the second hub. The balancing assembly is configurable to balance the propeller along a second axis.

In a third embodiment, a method is disclosed. The method includes suspending a propeller through a hub. The propeller comprises a first blade extending from a hub in a first direction along a first axis, a second blade extending from the hub in a second direction along the first axis, a first balancing ear extending from the hub in a third direction along a second axis, and a second balancing ear extending from the hub in a fourth direction along the second axis. The method also includes determining whether a propeller is balanced along the first axis. The method further includes determining whether the propeller is balanced along the second axis.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE DRAWINGS

FIG. 1A illustrates a propeller with two balancing ears, according to an example embodiment.

FIG. 1B illustrates a propeller with four balancing ears, according to an example embodiment.

FIG. 2A illustrates a propeller blade-assembly with a dual-ear balancing assembly, according to an example embodiment.

FIG. 2B illustrates a propeller blade-assembly with a multi-ear balancing assembly, according to an example embodiment.

FIG. 3 illustrates a method for balancing a propeller along multiple axes, according to an example embodiment.

### DETAILED DESCRIPTION

The following detailed description includes references to the accompanying figures. In the figures, similar symbols typically identify similar components, unless context dictates otherwise. The example embodiments described herein are not meant to be limiting. Other embodiments may be utilized, and other changes may be made, without departing from the scope of the subject matter presented herein. It will be readily understood that the aspects of the present disclosure, as generally described herein and illustrated in the figures can be arranged, substituted, combined, separated, and designed in a wide variety of different configurations, all of which are contemplated herein.

In existing model airplanes, propellers are generally balanced along a single horizontal, or lateral, axis. However, to more effectively balance a model airplane propeller, the propeller can be balanced along both a single horizontal or lateral axis and a vertical axis. When balancing along a vertical axis, traditionally, weight is added to, or removed from, the hub of the propeller. The change in weight is accomplished by either adding weights to the hub with tape, or by drilling holes in the hub of the propeller to remove a portion of the hub and the weight corresponding to the removed portion, for example.

The danger of removing portions of the hub is that the hub controls the pitch and tracking of the propeller blades. If too much material is removed from the hub in attempt to remove weight, for example, flight characteristics of the airplane will suffer as a result of the changed pitch and tracking of the propeller blades. Additionally, adding weight to the hub is often undesirable because the extra weight tends to reduce flight time. Moreover, it is difficult to (1) find an optimal weight amount; and (2) find the exact placement of that weight to vertically balance the propeller. Even further, adding weight is merely a temporary fix for imbalanced propellers and may not enable the model airplane to perform in a manner desired by hobby enthusiasts. Accordingly, a propeller that is configurable to be balanced on multiple axes in an efficient and accurate manner is desired.

Example embodiments disclosed herein relate to a model aircraft propeller configurable to balance the propeller along multiple axes. In an example embodiment, the propeller comprises a first blade extending from a hub in a first direction along a first axis, a second blade extending from the hub in a second direction along the first axis, a first balancing ear extending from the hub in a third direction along a second axis, and a second balancing ear extending from the hub in a fourth direction along the second axis. Using the first blade, the second blade, the first balancing ear, and the second balancing ear, the propeller may be balanced along both the first axis and the second axis.

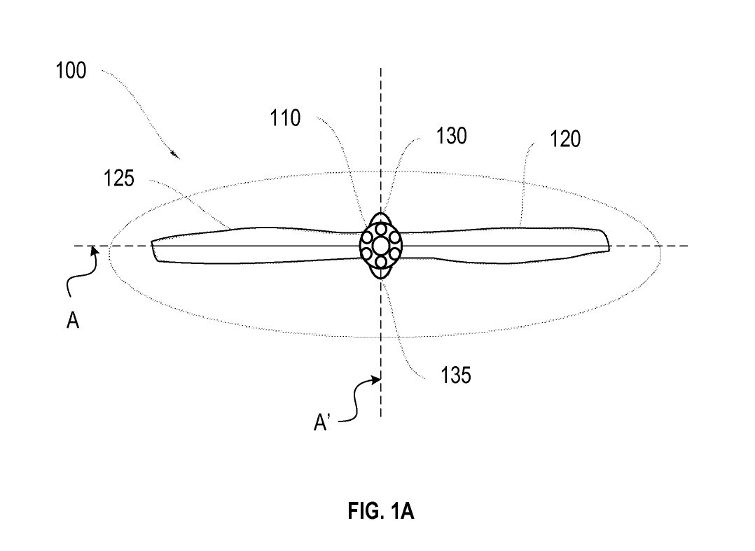

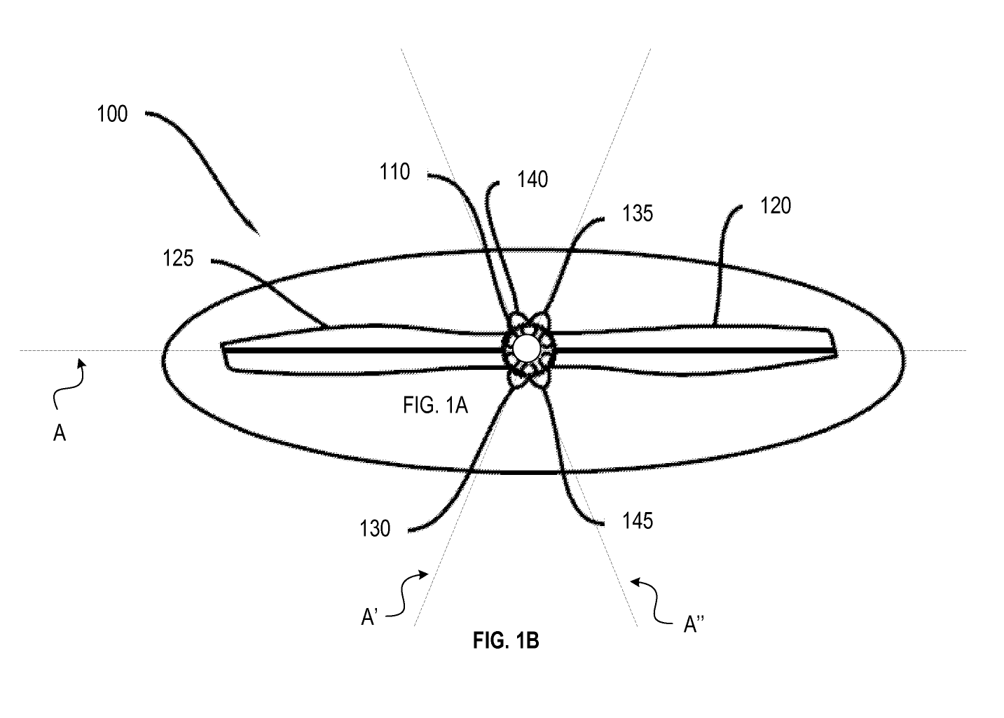

FIG. 1A illustrates a propeller 100 according to one embodiment. The propeller 100 includes a hub 110, a first blade 120, a second blade 125, a first balancing ear 130, and a second balancing ear 135.

In the embodiment shown in FIG. 1A, the first blade 120 and the second blade 125 are physically connected to the hub 110. Further, the first blade 120 and the second blade 125 are positioned opposite each other on the hub 110 along a first axis A. The first balancing ear 130 and the second balancing ear 135 are also physically connected to the hub 110. Similarly, the first balancing ear 130 and the second balancing ear 135 are positioned opposite each other on the hub 110 along a second axis A′. In a preferred embodiment, the first axis A is perpendicular or at least substantially perpendicular to the second axis A′.

To allow for the balancing the propeller of FIG. 1A, the propeller 100 is configurable to be first balanced along the first axis A by removing weight from the first blade 120 by, for example, sanding the first blade 120 until the weight of the side of the first blade 120 is equal to (or at least substantially equal to) the weight of the side of the second blade 125. Alternatively, the propeller 100 may be balanced along the first axis A by removing weight from the second blade 125, for example, by sanding the second blade 125 until the weight of the side of the second blade 125 is equal to (or at least substantially equal to) the weight of the side of the first blade 120. Other means exist to remove weight. For example, material of the first blade 120 may be grinded, cut, finished, scrapped, rubbed, scratched, or abraded, and is contemplated herein.

Alternatively, in another embodiment, the propeller 100 is configurable to be balanced along the first axis A by adding weight to the first blade 120 by, for example, applying cyanoacrylate to the first blade 120 until the weight of the side of the first blade 120 is equal to (or at least substantially equal to) the weight of the side of the second blade 125. Alternatively, the propeller 100 is balanced along the first axis A by adding weight to the second blade 125 by, for example, applying cyanoacrylate to the second blade 125 until the weight of the side of the second blade 125 is equal to (or at least substantially equal to) the weight of the side of the first blade 120. Other means exist to add weight. For example, tape, glue, urethane, enamel, paint, or balancing set screws may be added to the propeller 100, all of which are contemplated herein.

Similar to balancing the propeller along the first axis A, the propeller is 100 is configurable to be balanced along the second axis A′ by either adding weight to or removing weight from the first balancing ear 130 or the second balancing ear 135. Similar to removing weight from the first blade 120 and the second blade 125, weight may be removed from the balancing ears, for example by sanding, grinding, cutting, finishing, scraping, rubbing, scratching, or abrading the first balancing ear 130 and/or the second balancing ear 125. Weight may be added to the first balancing ear 130 and the second balancing ear 135, for example, by adding one or more of tape, glue, urethane, enamel, paint, or balancing set screws. Other material may be used to add weight. In some examples, the tape, glue, urethane, enamel, paint, or balancing set screws may be added to first balancing ear 130 and/or the second balancing ear 135 via a hole in the balancing ears configured to receive the weight adding material.

In other embodiments, the propeller 100 may include a third balancing ear and a fourth balancing ear. FIG. 1B illustrates propeller 100 with four balancing ears, according to another embodiment. Similar to FIG. 1A, in FIG. 1B propeller 100 includes a first blade 120, a second blade 125, a first balancing ear 130, and a second balancing ear 135, all of which are physically connected to the hub 110. Also similar to propeller 100 in FIG. 1A, the first blade 120 and the second blade 125 are positioned opposite each other along a first axis A, and the first balancing ear 130 and the second balancing ear 135 are positioned opposite each other along a second axis A′. However, in FIG. 1B propeller 100 includes a third balancing ear 140, and a fourth balancing ear 145 that extend from the hub 110 along a third axis A″. The third balancing ear 140 extends in a fifth direction, and the fourth balancing ear 145 extends in a sixth direction. In FIG. 1B the first balancing ear 130 is positioned opposite the second balancing ear 135, and the third balancing ear 140 is positioned opposite the fourth balancing ear 145. In this embodiment, the first axis A and the third axis A″, and the first axis A and the third axis A″, are substantially 60 degrees relative to each other. The third balancing ear 140 and the fourth balancing ear 145 may be used to further balance the propeller 100.

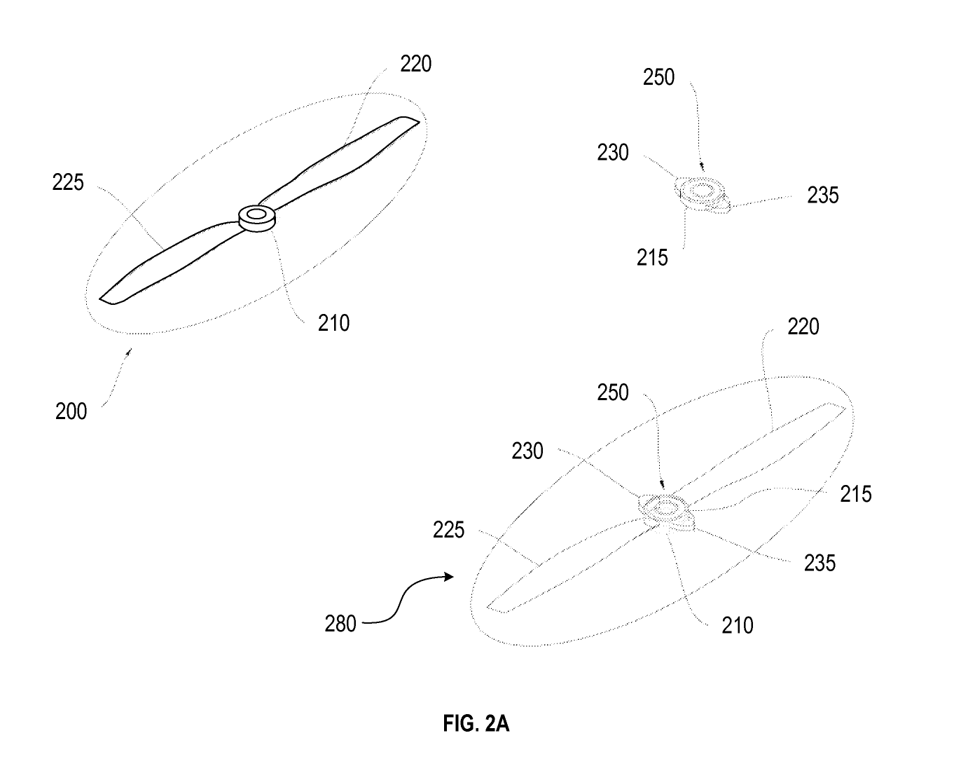

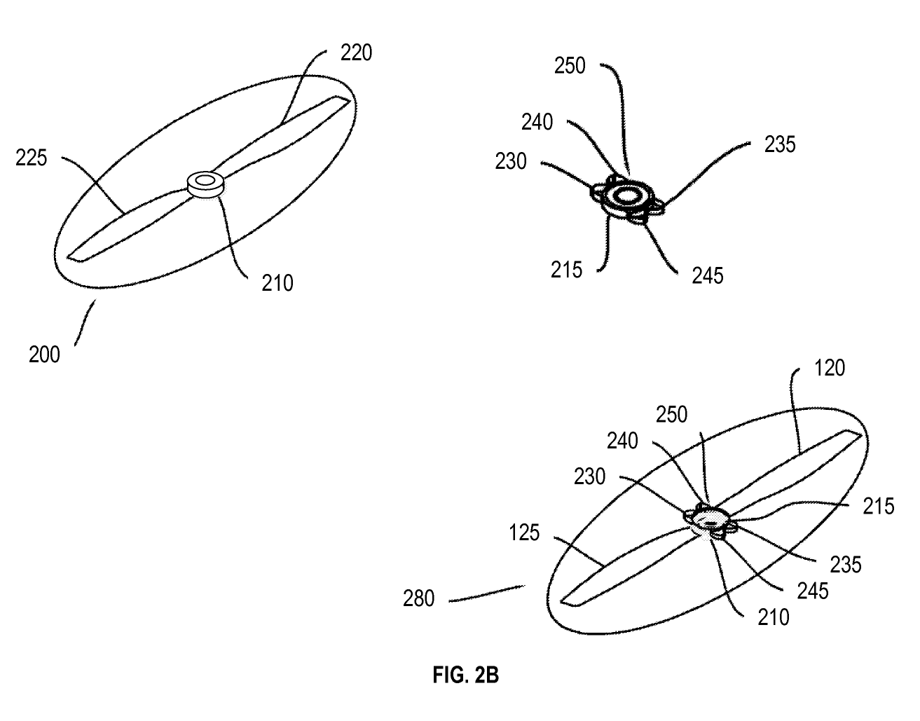

FIG. 2A illustrates a blade assembly 200 and a balancing assembly 250 according to another embodiment. The blade assembly 200 includes a hub 210, a first blade 220, and a second blade 225. The balancing assembly 250 includes a second hub 215, a first balancing extension 230, and a second balancing extension 235.

In the embodiment shown in FIG. 2A, the first blade 220 and the second blade 225 are physically connected to the hub 210. Further, the first blade 220 and the second blade 225 are positioned opposite each other along the hub 210, and extend from the hub 210. Similarly, the first balancing extension 230 and the second balancing extension 235 are physically connected to the second hub 215 and are positioned opposite each other along the second hub 215. Both the first balancing extension 230 and the second balancing extension 230 extend from the second hub 210. The balancing assembly 250 is mechanically coupled to the blade assembly 200 prior to balancing the propeller apparatus 280.

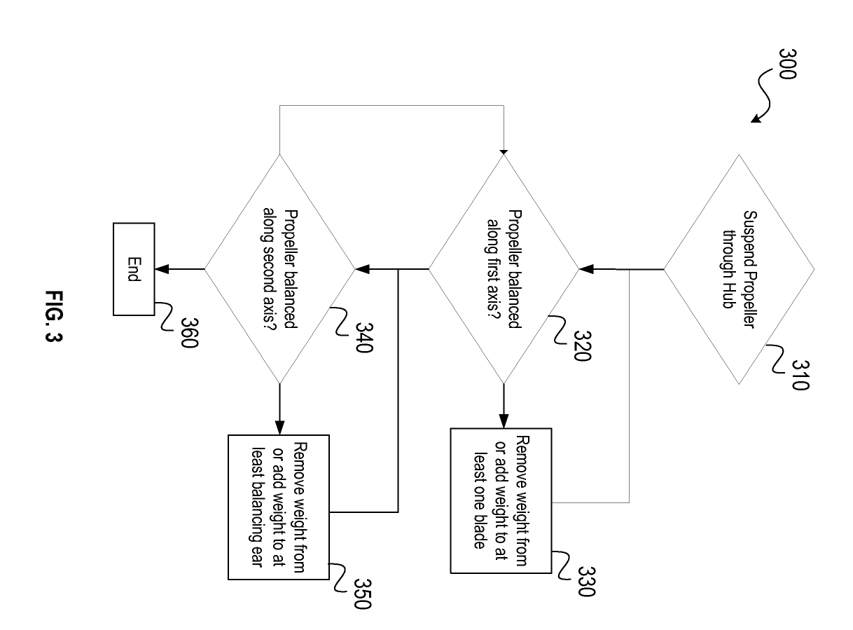

In one embodiment, the balancing assembly 250 is mechanically coupled to the blade assembly 200 using metal screws to create a propeller apparatus 280 that includes the blade assembly 200 and the balancing assembly 250. The propeller apparatus 280 is then suspended through an opening within the hub 210 of the blade assembly 200 and second hub 215 of the balancing assembly 250. Next, the propeller apparatus 280 is balanced along the first axis A (shown in FIG. 1A) by either adding weight to, or removing weight from, at least one of the first blade 220 or the second blade 225. After the propeller apparatus 280 is balanced along the first axis A, the propeller apparatus 280 is balanced along the second axis A′ (shown in FIG. 1A) by either adding weight to, or removing weight from, at least one of the first balancing extension 230 or the second balancing extension 235. In one embodiment, the balancing process is accomplished according to the process shown and described with respect to FIG. 3.

In other embodiments, the balancing assembly 250 may have a third balancing extension 240 and a fourth balancing extension 245 as shown in FIG. 2B. The third balancing extension 240 and the fourth balancing extension 245 may be physically attached to the second hub 215 and are positioned opposite each other. Similar to the balancing assembly 250 shown in FIG. 2A, the balancing assembly of FIG. 2B, 250, may be mechanically coupled to the blade assembly 200 to create a propeller apparatus 280. The propeller apparatus 280 may then be balanced in a manner similar to that discussed with regard to the propeller apparatus 280 in FIG. 2A, but by also adding weight to, or removing weight from, at least one of the third balancing ear 240 and the fourth balancing ear 245.

The propeller 100 and the propeller apparatus 280, described in FIGS. 1A and 2A respectively, may be manufactured in a variety of materials. In one embodiment, for example, the propeller 100 may be constructed of wood, for example. Alternatively, the propeller 100 may be constructed of plastic, carbon-fiber, fiberglass, nylon fiber composite, hand-laid fiber composite, or metal, or any other suitable material. In some embodiments, the propeller blades 120, 125 may be manufactured from a different material than the hub 110. Similarly, the balancing ears 130, 135 may also be manufactured from a different material than the hub 110. In still further embodiments, the propeller blades 120, 125, the balancing ears 130, 135, and the hub 110 may be manufactured from different materials. Similarly, with respect to the propeller apparatus 280 of FIG. 2A, the blades 220, 225, the extensions 230, 235, the first hub 210, and the second hub 215 can be manufactured from the same material or any combination of the materials described herein. In some embodiments, the materials for the hubs, blades, and balancing ears can be selected according to their cost, weight, durability, and/or ease with which weight may added and/or removed, for example.

FIG. 3 illustrates a method 300 for dual-axis balancing of a propeller, according to an example embodiment. This method may be carried out, for example, using the propeller 100 described in FIG. 1A. First, at step 310, the propeller 100 is suspended through a hub 110 of the propeller 100. The propeller 100 may be suspended, for example, by inserting an elongated shaft into the hub 110 thereby suspending the propeller 110, allowing first blade 120 and second blade 125 to rotate freely. Other techniques may be used to suspend the propeller. Once the propeller is suspended, at step 320, it is determined whether the propeller is balanced along a first axis. If the propeller is balanced, the first blade 120 and the second blade 125 will remain motionless. An unbalanced propeller will rotate towards the heavier blade. For example, referring to FIG. 1A, if propeller 100 is unbalanced along the first axis A, because the first blade 120 is heavier than the second blade 125, then the first blade 120 of the propeller will naturally rotate downwards (counter-clockwise) away from axis A. Other methods exist to determine whether the propeller 110 is balanced along the first axis. If the propeller is balanced along the first axis, the process proceeds to step 340. If the propeller is not balanced along the first axis A, the process proceeds to step 330. At step 330, weight is removed from at least one of the first blade 120 or the second blade 125 to achieve weight balance along the first axis A. Alternatively, at step 330, weight is added to at least one of the first blade 120 or the second blade 125 to achieve weight balance along the first axis A.

After the propeller is balanced along the first axis A, the process then proceeds to step 340. At step 340, it is determined whether the propeller is balanced along a second axis A′. In a preferred embodiment, the second axis A′ is perpendicular to (or at least substantially perpendicular to) the first axis A. If the propeller is balanced along the second axis A′, then the process proceeds to step 360. If the propeller is not balanced along the second axis A′, then the process proceeds to step 350. At step 350, weight is removed from at least one of the first balancing ear 130 or the second balancing ear 135 to achieve weight balance along the second axis A′. Alternatively, at step 350, weight is added to at least one of the first balancing ear 130 or the second balancing ear 135 to achieve weight balance along the second axis A′. After the propeller 100 is balanced along the second axis, the process may be concluded at step 360.

In some embodiments, balancing the propeller 100 along the second axis A′, will influence the balance along the first axis A (previously balanced at step 320). Under these circumstances, after the propeller 100 is balanced along the second axis A′ using the foregoing process, at step 340, the propeller may be re-balanced along the first axis A, returning to step 320. This back-step process may be repeated until the propeller is balanced along the first axis A and the second axis A′ as desired. Once the propeller 100 is balanced along both the first axis A, and the second axis A′ the process may be concluded at step 360.

The process shown and described with respect to FIG. 3 can also be used with the embodiments shown and described with respect to FIGS. 1B, 2A, and 2B. For example with reference to the embodiment of FIG. 2B, steps 320 and 330 are followed in connection with the blades 220, 225 of the blade assembly 200, and steps 340 350 are followed in connection with the balancing extension 230 and 235 of the balancing assembly 250. In some embodiments, after steps 320, 330, 340, and 350 have been completed, the blade assembly 200 and balancing assembly 250 are packaged together to be sold as a dual-axis balanced propeller apparatus 280, for example. In other embodiments, the blade assembly 200 and balancing assembly may be sold separately (in separate packaging or in the same packaging) so that an end user can connect the blade assembly 200 with the balancing assembly 250 to form the propeller apparatus 280.

The disclosed embodiments improve upon prior art propellers by providing a system and method to balance a propeller along multiple axes. Specifically, the balancing ears are used to balance the propeller along axes that are different than the axis upon which the blades of the propeller rest. Removal of portions of the balancing ears is unlikely to affect the pitch or tracking of the blades, as could be the case in the prior art by removal of portions of the hub. Further, the addition of the balancing ears is preferable to taping or adding weights to or in the hub. If using the balancing ears, a correct weight does not have to be searched for and the placement of that weight does not have to be guessed. The balancing ears are placed correctly at production and can easily be modified to achieve a desired balance. Further, the balancing ears of the disclosed embodiments provide a better balance solution than prior propellers and match the level of professionalism to which many hobby enthusiasts strive.

While particular aspects and embodiments are disclosed herein, other aspects and embodiments will be apparent to those skilled in the art in view of the foregoing teaching. The various aspects and embodiments disclosed herein are for illustration purposes only and are not intended to be limiting, with the true scope and spirit being indicated by the following claims.

What is claimed is:

1. A propeller comprising:
a first blade extending from a hub in a first direction along a first axis;
a second blade extending from the hub in a second direction along the first axis;
a first balancing ear extending from the hub in a third direction along a second axis; and
a second balancing ear extending from the hub in a fourth direction along the second axis.

2. The propeller of claim 1, wherein the first axis and the second axis are substantially perpendicular to each other.

3. The propeller of claim 1, wherein the first blade and the second blade are configurable to balance the propeller along the first axis, and wherein the first balancing ear and the second balancing ear are configurable to balance the propeller along the second axis.

4. The propeller of claim 1, wherein each of the first blade, the second blade, the first balancing ear, and the second balancing ear components is configurable to remove weight by at least one of sanding the component, grinding the component, cutting the component, finishing the component, scraping the component, rubbing the component, scratching the component, and abrading the component.

5. The propeller of claim 1, wherein the first balancing ear and the second balancing ear each comprise at least one structure configured to receive a weight-adding material.

6. The propeller of claim 5, wherein the at least one structure comprises a hole configured to receive the weight-adding material.

7. The propeller of claim 1, further comprising:
a third balancing ear extending from the hub in a fifth direction along a third axis; and
a fourth balancing ear extending from the hub in a sixth direction along the third axis.

8. The propeller of claim 7, wherein the first axis and the second axis, and the first axis and the third axis are substantially 60 degrees relative to each other.

9. The propeller of claim 7, wherein the first blade and the second blade are configurable to balance the propeller along the first axis, wherein the first balancing ear and the second balancing ear are configurable to balance the propeller along the second axis, and wherein the third balancing ear and the fourth balancing ear are configurable to balance the propeller along the third axis.

10. The propeller of claim 8, wherein the third balancing ear and the fourth balancing ear each comprise a structure configured to add weight-adding material.

11. An apparatus comprising a propeller, the propeller comprising:
a blade assembly comprising a first blade, a second blade, and a hub, wherein
the hub has a center mounting hole;
the first blade and the second blade are disposed around the center mounting hole and extending from the hub; and
the blade assembly is configurable to balance the propeller along a first axis; and
a balancing assembly comprising a first balancing extension, a second balancing extension, and a second hub, wherein
the second hub has a second center mounting hole;
the first balancing extension and the second balancing extension are disposed around the second center mounting hole and extending from the second hub; and
the balancing assembly is configurable to balance the propeller along a second axis.

12. The apparatus of claim 11, wherein the first axis and the second axis are substantially perpendicular to each other.

13. The apparatus of claim 11, wherein each of the first blade, the second blade, the first balancing extension, and the second balancing extension components is configurable to remove weight therefrom by at least one of sanding the component, grinding, the component cutting the component, finishing the component, scraping the component, rubbing the component, scratching the component, and abrading the component.

14. The apparatus of claim 11, wherein each of the first blade, the second blade, the first balancing extension, and the second balancing extension components is configurable to receive weight-adding material.

15. The apparatus of claim 11, further comprising a second balancing assembly comprising a fourth balancing extension, a fifth balancing extension, and a third hub wherein
the third hub has a third center mounting hole;
the second balancing assembly is disposed around the third center mounting hole and extending from the hub; and
the second balancing assembly is configurable to balance the propeller along a third axis.

16. The apparatus of claim 11, wherein each of the first blade, the second blade, the first balancing extension, the second balancing extension, the third balancing extension, and the fourth balancing extension components is configurable to remove weight therefrom by at least one of sanding the component, grinding, the component cutting the component, finishing the component, scraping the component, rubbing the component, scratching the component, and abrading the component.

17. The apparatus of claim 15, wherein the first axis and the second axis, and the first axis and the third axis are substantially 60 degrees relative to each other, and wherein the third balancing ear and the fourth balancing ear each comprise a structure configured to add weight-adding material.

18. A method for balancing a propeller about a center of gravity comprising:
suspending the propeller through a hub, wherein the propeller comprises a first blade extending from a hub in a first direction along a first axis, a second blade extending from the hub in a second direction along the first axis, a first balancing ear extending from the hub in a third direction along a second axis, and a second balancing ear extending from the hub in a fourth direction along the second axis;
determining whether a propeller is balanced along the first axis; and
determining whether the propeller is balanced along the second axis.

19. The method of claim 18, further comprising, in response determining that propeller is not balanced along the first axis, removing weight from at least one of the first blade and the second blade or adding weight to at least one of the first blade and the second blade in a manner so as to balance the propeller.

20. The method of claim 18, further comprising, in response to determining that the propeller is not balanced along the second axis, removing weight from at least one of the first balancing ear and the second balancing ear or adding weight to at least one of the first balancing ear and the second balancing ear in a manner so as to balance the propeller.
